(19) United States
(12) Patent Application Publication
(10) Pub. No.: US 2007/0272896 A1
(43) Pub. Date: Nov. 29, 2007

(54) Twisted nematic liquid crystal display and application thereto

(76) Inventors: Chen-Chi Lin, Padeh City (TW); Chuen-Ru Lee, Padeh City (TW); Hui-Mei Hu, Padeh City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/475,142

(22) Filed: Jun. 27, 2006

(30) Foreign Application Priority Data
May 23, 2006 (TW) 95118280

(51) Int. Cl. C09K 19/42; C09K 19/30; C09K 19/12; C09K 19/52

(52) U.S. Cl. 252/299.01; 252/299.63; 252/299.66

(57) ABSTRACT

A nematic liquid crystal composition includes a mixture of first component and second component as follows: a first component with at least one first twisted-related characteristic, wherein the first component is from 75% to 90% in total weight of the nematic liquid crystal composition; and a second component with at least one second twisted-related characteristic lower than the first twist-related characteristics, wherein the second component is from 10% to 25% in total weight of the nematic liquid crystal composition.

### BACKGROUND OF THE INVENTION

1. Field of the Invention

The present invention generally relates to the twisted nematic liquid crystal display, and more particularly relates to the composition of the nematic liquid crystal.

2. Description of the Prior Art

At present, liquid crystal display (LCD) has found varieties of applications as a thin full color display. The twisted nematic (TN) mode has become one of the standard today. Almost all active matrix drives displays use TN type LCD. The TN type liquid crystal is used as dielectric between the electrodes of such display cells, the molecular arrangement of the liquid crystal is altered to cause variation in optical characteristics such as birefringence, optical rotatory power, dichroism, scattering and optical rotatory dispersion. To improve the general characteristic of the composition can lead to the product of the TN LCD having images in good quality.

The main body of the TN LCD includes a liquid crystal unit and two polarizers. The liquid crystal panel includes two parallel glass substrates covered by transparent electrodes and alignment films. Between the glass substrates, the liquid crystal molecules may continuously twist the molecular orientation along a direction of the alignment film to obtain a twist angle of 90 degree. This is the so-called twisted nematic liquid crystal.

In the convention twisted nematic liquid crystal display, the liquid crystal panel include a first polarizer and a second polarizer whose polarization axes are perpendicular to each other, and the liquid crystal molecules positioned between the first glass substrate and a second glass substrate. Since the polarization axes of the first polarizer and the second polarizer are perpendicular to each other, the twisted angle of the liquid crystal molecules from the first glass substrate to the second glass substrate is 90 degree. On the other hand, the liquid crystal molecules alignment on each of the glass substrates is parallel to the polarization axes of the corresponding polarizers. Thus, while light beams are incident onto the first polarizer with a right angle, only the portion of the incident light beams parallel to the polarization axis of the first polarizer can pass through to enter the liquid crystal medium, then twisted along the orientation of the liquid crystal molecules with a right angle and pass the output polarizer, so the panel is normal white in the “off-state”.

Accordingly, an important characteristic of the nematic liquid crystal is dielectric anisotropy(ΔE). As an applied voltage greater than a threshold one essentially causes the twisted angle to be destroyed so that the molecular arrangement is no longer optically active. Thus, when placed between plane polarizers a twisted nematic effect device provides one or more optical shutters which are switchable from a light state to a dark state. So the dielectric anisotropy is the corresponding amount of inversion of the nematic liquid crystal that according to the gray level performance.

By the above-mentioned, because the liquid crystal is twisted, the cross angles between the liquid crystal molecules and the straight polarized light of the normal direction of the substrates and the straight polarized light passing through by an angle are different. This is because the optical anisotropy(Δn) of the liquid crystal molecules, thus, while the straight polarized light pass through the liquid crystal molecules producing two types of light, ordinary refractive light and extraordinary refractive light, and become an ellipse polarized light. It is the factor causes the view angle dependency of the twisted nematic liquid crystal display. Please refer to FIG. 1. FIG. 1 is the schematic diagram to show when the viewer 18 from different directions 12, 14, 16 to view the liquid crystal display 10, the liquid crystal molecules 11 will present the different tilt angles of the liquid molecules to show the different vision 101, 102, 103. It is so called the view angle dependency.

For improving the essential defect of the TN liquid crystal display, the various technology methods have been disclosed. All of these technology methods have to increase the process step to achieve the goal, therefore increasing the manufacture cost and the risk of reducing the product yield.

### SUMMARY OF THE INVENTION

An object of the present invention is to provide a liquid crystal composition originating from mixing two different twist-related characteristics of the liquid crystal molecules, which may reduce the variance of retardation(Δnd) to improve the dependency of the view angle and satisfy the plurality of physical and optical characteristics, i.e. a low viscosity, a suitable optical anisotropy, and a small dielectric anisotropy.

One of objects of the present invention is to provide a liquid crystal display with the liquid crystal composition, which has a short response time and can improve the gray-level inverse and color shift.

To achieve the previous mention, one embodiment of the present invention provides a nematic liquid crystal composition applied to the liquid crystal material of a multiplexed twisted nematic electro-optical display including a mixture of the first component and the second component, in which, a first component with at least one first twisted-related characteristic, wherein the first component is from 75% to 90% in total weight of the nematic liquid crystal composition; and a second component with at least one second twisted-related characteristic lower than the first twist-related characteristic, wherein the second component is from 10% to 25% in total weight of the nematic liquid crystal composition.

### BRIEF DESCRIPTION OF THE DRAWINGS

The foregoing aspects become better understood by reference to the following drawings, wherein:

FIG. 1 is a schematic diagram to show the view angle dependency of a convention twisted nematic liquid crystal display in accordance with one prior art;

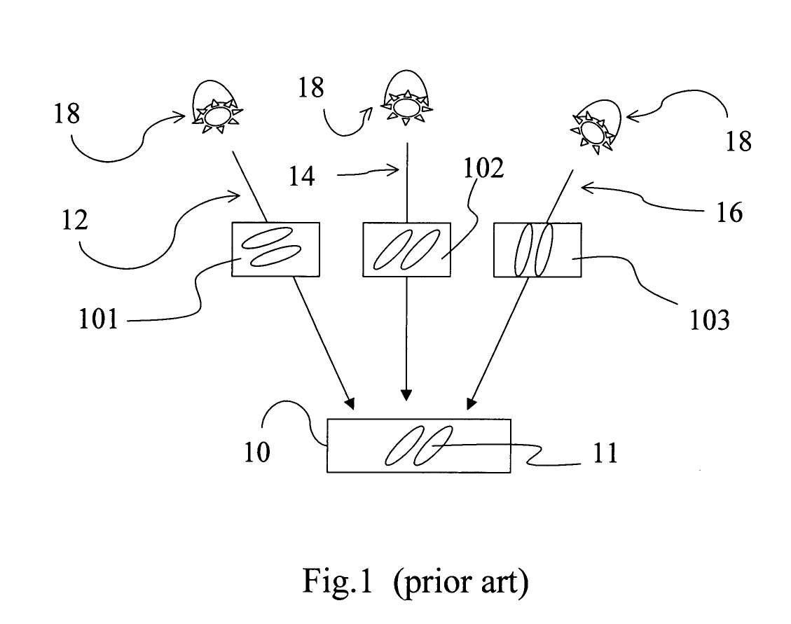

FIG. 2 is a schematic diagram to show the improvement in the view angle dependency of the preferred embodiment of the present invention; and

FIG. 3 is a section view to show the active matrix liquid crystal display of the preferred embodiment of the present invention.

### DESCRIPTION OF THE PREFERRED EMBODIMENT

One embodiment of the present invention provides a nematic liquid crystal composition applied to a multiplexed twisted nematic electro-optical display. The nematic liquid crystal composition includes the mixture of at least two components with different characteristics, for example, a first component with the first twist-related characteristics and second component with the second twist-related characteristics. For example, the first twist-related characteristic is a first positive optical anisotropy higher than a second optical anisotropy of the second twist-related characteristic. Alternatively, the first twist-related characteristic is a first dielectric anisotropy higher than a second dielectric anisotropy of the second twist-related characteristic. The mixture includes from 75% to 90% of the first component in the total weight of the mixture which is used for the main body of the nematic liquid crystal display media to transmit incident light, and from 25% to 10% of the second component in the total weight of the mixture which is used for adjusting or compensating the twisted-related characteristics.

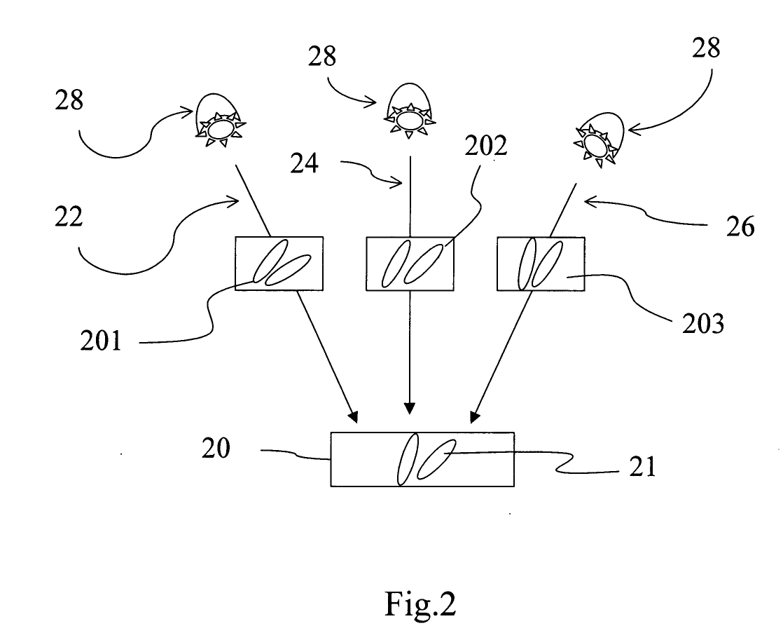

The second component selected to adjust the values of the dielectric anisotropy or the optical anisotropy is for preventing the fast refractive index change from influencing the quality of the image especially the view angle dependency. Please refer to FIG. 2. FIG. 2 is a schematic diagram to show the improvement in the view angle dependency. When applied a voltage to the liquid crystal display, liquid crystal molecules present at least two different inclinations to transmit the incident light. Therefore, while the viewer 28 views the liquid crystal molecules 21 in liquid crystal display 20 from different directions 22, 24, 26, it will present almost the same vision effects of 201, 202, 203.

The nematic liquid crystal composition is formed from mixing the first component and the second component in proper proportion. Next, the mixture temperature is raised to the phase transition temperature and then lowered to room temperature. After the foregoing processes, the nematic liquid crystal composition is still a homogenous alignment compound as the first component and the second component. Therefore, when the nematic liquid crystal composition is filled between the two substrates and applied a proper voltage, the twisted nematic electro-optical effect is presented.

The first component and the second component may be individually selected from the group of compounds represented by formulas (1), (2), and (3) as follow:

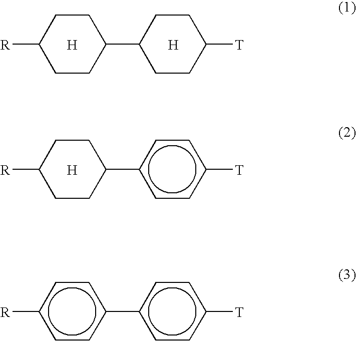

Wherein the R and the T in the formulas (1), (2), and (3) are individual the optional substituted group in which the dipole moment of the T group is stronger than the R group. R, for example, may be alkyl, aryl, and alkenyl and the T may be substituted by the group of the 2,3,4-trifluorobenzo-, the group of the 2,3,4-trifluorobenzo-oxo-difluoromethyl, and the group of the 3,5-difluoro-4-methoxylbenzo. Alternatively the R may be substituted by the straight-chain or branched alkyl group, and the T may be substituted by straight-chain or branched of the alkyl.

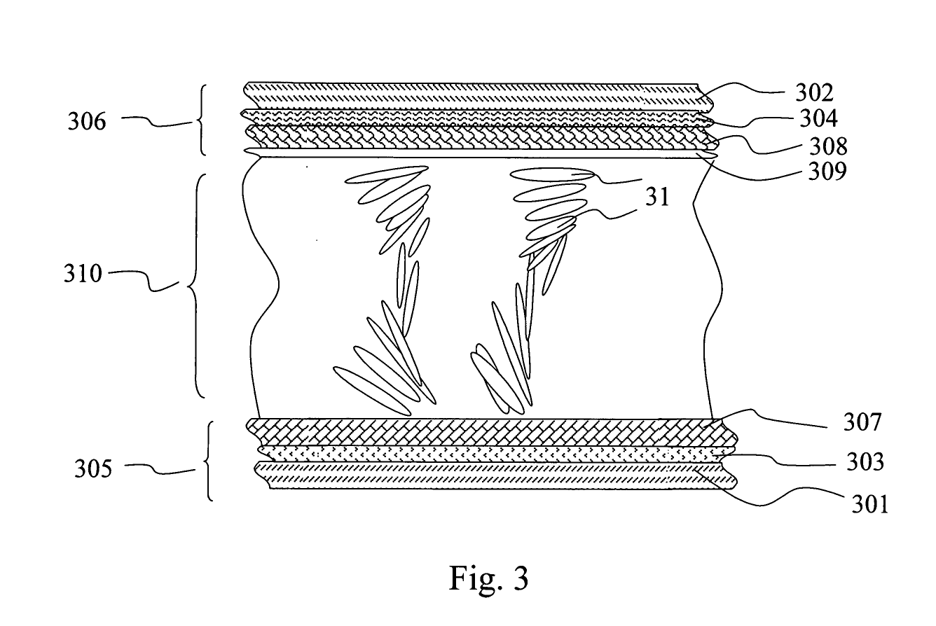

Another one embodiment of the present invention provides an active matrix liquid crystal display with the mixture of the liquid crystal compound. Shown in FIG. 3, an exemplary active matrix liquid crystal display may include the structure of first substrate 305, the structure of second substrate 306, and a layer of nematic liquid crystal 310 positioned between the structure of first substrate 305 and the structure of second substrate 306. In one embodiment, the structure of first substrate 305 may include a first polarizer 301, a TFT array substrate 307, and a first orientation film 303 between the TFT array substrate 307 and the first polarizer 301. The structure of second substrate 306 may be formed by stacking a second polarizer 302, a second orientation film 304, a color filter 308, and a common electrode 309. The layer of nematic liquid crystal 310 may include a plurality of crystal liquid molecules 31. In the embodiment, the nematic liquid crystal molecules 31 may originate from two components with the different threshold voltages of nematic liquid crystal and be homogenously aligned in the pixels when the pixels are off-state.

Similar as the weight ratios of the first embodiment, the layer of nematic liquid crystal of the second embodiment may include the first component from 90% to 75% and the second component from 10% to 25% by the ratio based on the total weight of the layer of nematic liquid crystal. In an active matrix LCD, the non-linear switching elements are addressed in a multiplex scheme. They charge to the TFT of a pixel from a matrix driving circuit in the limited time they are active. Then they become inactive until they are addressed again in the next cycle. Accordingly, the liquid crystal molecules may show short response time and reduced viscosity. For example, the large positive dielectric anisotropy of at least +3.5 recommend, increasing the voltage holding ratio up to 98%, and the positive dielectric anisotropy or the optical anisotropy of the second component must be less than the positive dielectric anisotropy or the optical anisotropy of the first component.

In the present invention, when applied a driving voltage to the TFTs of the pixels at least two different inclinations of the nematic liquid crystal show in the pixels of the active matrix LCD. The driving voltage is referred to as a gray level voltage to control the intensity of light transmitted through the pixels. A gray level voltage is generally known as any driving voltage greater than threshold voltage up to about 1.0 to 4.5 volts, and used to generate dissimilar shades of color so as to create different colors and images. The higher the gray voltage is applied across to the nematic liquid crystal of selected said pixels, the weaker the intensity of light transmitted is.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A nematic liquid crystal composition applied to a multiplexed twisted nematic electro-optical display, the nematic liquid crystal composition comprising:
a first component with at least one first twisted-related characteristic, wherein said first component is from 75% to 90% in total weight of the nematic liquid crystal composition; and
a second component with at least one second twisted-related characteristic lower than said first twist-related characteristic, wherein said second component is from 10% to 25% in total weight of the nematic liquid crystal composition.

2. The nematic liquid crystal composition according to claim 1, wherein a mixture originated from said first component and said second component is implemented by a process of rising up a temperature of phase transformation for said first component and said second component then decreasing to a room temperature.

3. The nematic liquid crystal composition according to claim 2, wherein said mixture is a homogenous alignment compound after said process.

4. The nematic liquid crystal composition according to claim 1, wherein said first twist-related characteristic or said second twist-related characteristic is dielectric anisotropy.

5. The nematic liquid crystal composition according to claim 1, wherein said first twist-related characteristic or said second twist-related characteristic is optical anisotropy.

6. A twisted nematic liquid crystal display, comprising a mixture of first component and second component, said mixture including said first component from 75% to 90% by total weight and the second component from 25% to 10% by total weight;
Wherein said first component and said second component are individually selected from the group of compounds consisted of formulas (1), (2), and (3) as follows: 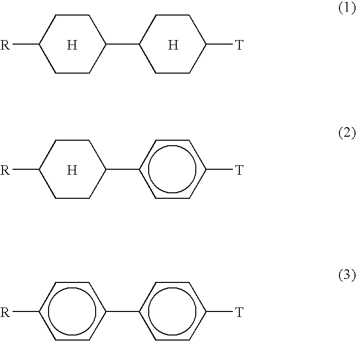
Wherein said R and T in the formulas are the optional substituted group of an organic compound.

7. The twisted nematic liquid crystal display according to claim 6, wherein the dipole moment of the T group is stronger than said R group.

8. The twisted nematic liquid crystal display according to claim 6, wherein said R is alkyl, aryl, or alkenyl.

9. The twisted nematic liquid crystal display according to claim 6, wherein said T is substituted by the group of the 2,3,4-trifluorobenzo-.

10. The twisted nematic liquid crystal display according to claim 6, wherein said T is substituted by the group of 2,3,4-trifluorobenzo-oxo-difluoromethyl.

11. The twisted nematic liquid crystal display according to claim 6, wherein said T is substituted by the group of 3,5-difluoro-4-methoxylbenzo-.

12. The twisted nematic liquid crystal display according to claim 6, wherein the R is substituted by the straight-chain or branched alkyl group, the T can be substituted by the straight-chain or branched of alkenyl.

13. An active matrix liquid crystal display, comprising:
a structure of first substrate;
a structure of second substrate parallel to said structure of first substrate; and
a layer of nematic liquid crystal molecules between said structure of first substrate and said structure of second substrate;
wherein said layer of nematic liquid crystal molecules comprises a first component and second component with different threshold voltages.

14. The active matrix liquid crystal display according to claim 13, wherein said first component is from 90% to 75% in total weight of said layer of nematic liquid crystal.

15. The active matrix liquid crystal display according to claim 13, wherein said second component is from 10% to 25% in total weight of said layer of nematic liquid crystal.

16. The active matrix liquid crystal display according to claim 13, wherein at least two different inclinations of said nematic liquid crystal show in said pixel, when applied a same driving voltage to said TFT of said pixel supplied by said active matrix driving circuit.

17. An active matrix liquid crystal display according to claim 13, wherein said positive dielectric anisotropy of said first component and said second component is at least +3.5, and the positive dielectric anisotropy or the optical anisotropy of said second component must be less than the positive dielectric anisotropy or the optical anisotropy of said first component.
